(19) United States
(12) Patent Application Publication
(10) Pub. No.: US 2025/0058870 A1
(43) Pub. Date: Feb. 20, 2025

(54) HYBRID-USE ROTARY-WING AIRCRAFT WITH ALIGNED DRIVETRAIN

(71) Applicant: ROZE MOBILITY, MORGES 01 (DE)

(72) Inventor: Grégoire BOURGUIGNON, GESPUNSART (FR)

(21) Appl. No.: 18/728,214

(22) PCT Filed: Jan. 13, 2023
(86) PCT No.: PCT/EP2023/050783

§ 371 Date: Jul. 22, 2024

(30) Foreign Application Priority Data
Jan. 14, 2022 (FR) FR2200276
Jan. 14, 2022 (FR) FR2200277

(51) Int. Cl. B64C 27/12; B64C 1/00; B64C 27/06; B64C 27/82; B64U 10/17

(52) U.S. Cl. CPC B64C 27/12; B64C 27/06; B64C 27/82; B64U 10/17; B64C 2001/0072

(57) ABSTRACT

Rotary-wing aircraft, comprising:
a drive motor (12) with a motor output shaft (12-3),
a transfer gearbox (14) having the motor output shaft (12-3) as an input and having a first output (14-1) and a second output (14-2),
a cockpit with associated cockpit electronics,
a rotary wing with rotor and blades,
a tail and tail rotor (20) with a drive shaft (20-1) for driving the tail rotor, and
a skids unit with equipment suited to the intended application, characterized in that the motor shaft (12-3) of the motor (12), the transfer gearbox (14) with its second output (14-2) and the drive shaft (20-1) that drives the tail rotor (20) are aligned.

The invention relates to a rotary-wing aircraft with an aligned drivetrain. This is a hybrid-use aircraft, with passengers in piloted mode and cargo in drone mode.

In the aeronautical world, a category of aircraft is classified as VLA, from the English trigram Very Light Aircraft. These very light aircraft follow different rules from those of aircraft, both in terms of the construction itself and maintenance. This has led to a number of innovations, and opened up flying to many new enthusiasts. Constraints remain for this type of classification, as for all aircraft, with weight being the most important. It should be noted that excess weight is always to be avoided, because for the same power output, the heavier the structure, the more limited the load carried, whether passengers, freight or other items. Moreover, it is a vicious circle: the heavier the structure, the more power is needed, and the more power needed, the more fuel needed, unless the range is to be limited. Thus, it always involves a compromise.

The field concerned by the present invention is a rotary-wing aircraft in the Very Light Aircraft (VLA) category.

As is known, a rotary-wing aircraft comprises the following main parts:
an airframe, to accommodate pilots/passengers or to house the electronic means of autonomous piloting,
a motor associated with a fuel tank,
a rotary wing comprising at least two blades, rotating in a substantially horizontal plane, tiltable over a given angular range,
a first transmission, with a substantially vertical axis of rotation, interposed between the motor and said rotary wing,
an anti-rotation rotor, rotating in a substantially vertical plane,
a second transmission, with a substantially horizontal axis of rotation, interposed between said motor and said anti-rotation rotor,
a tail to support the anti-rotation rotor and keep it away from the rotating wing,
ground skids, on which the aircraft rests.

The VLA design is identical to that of certified aircraft, but the weight criterion is prohibitive for remaining in this flight class, and the weight is necessarily more limited, depending on legislation and changes in that legislation. In addition, the weight of VLA-class aircraft must be limited to allow the carriage of two passengers, or the largest possible load in drone mode.

Moreover, existing aircraft have a different center of gravity depending on whether they are empty or loaded. Weight is therefore a concept that must be anticipated, and according to the known art, counterweights are provided in the architecture of the empty aircraft to balance, for example, the weight of the motor by advantageously positioning passengers or dead weights.

The aircraft according to the present invention consists in providing an architecture common to both modes, the piloted mode with passenger carriage and the drone mode with load carriage, whether the applications are civil, military, private or commercial. The aim of the present invention is also to enable the said rotary-wing aircraft to be transported from the parking or manufacturing area to any place where it is to be used or developed. However, this location may be a long way from the aircraft's place of residence. Moreover, this location can also be modified to suit one's needs. In fact, the aircraft must be able to be dismantled for transfer within a limited volume, and therefore at limited cost. Load-carrying applications are numerous, in the military, in agriculture for phytosanitary treatment of large areas, or for supplying sites inaccessible other than by air, to name but a few. The autonomy of the rotary-wing aircraft according to the present invention is perfectly suited to local missions, and enables work to be carried out within a radius of action of the order of 250 kms, to give an idea. Furthermore, in the load-carrying version, removable load-securing means must be able to be provided so that a container can be installed intended for receiving parcels, spraying means with associated tanks containing the phytosanitary product, surveillance and control cameras, measurement sensors or military grade weapons, again just to mention these applications.

The rotary-wing aircraft according to the invention comprises:
a drive motor with a motor output shaft,
a transfer gearbox with a first output and a second output,
a cockpit with associated cockpit electronics,
a rotary wing with rotor and blades,
a tail and the tail rotor thereof, and
a skids unit with equipment suited to the intended application,
   and is characterized in that the motor drive shaft, the transfer gearbox with its second output and the tail rotor drive shaft are aligned.

This rotary-wing aircraft has a structural core and this structural core is monolithic.

More particularly, the structural core is made of carbon fiber composites and includes lateral housings suitable for accommodating the fuel tanks required to supply the drive motor.

The rotary-wing aircraft according to the invention comprises a skids unit connected to the structural core by quick-release fasteners.

In particular, the tail comprises a connecting flange and the structural core comprises an attachment flange able to cooperate with said connecting flange.

According to another feature, the structural core comprises a cradle designed to receive the drive motor.

According to a specific architectural feature, the motor output shaft, the transfer gearbox with its first output to the rotary wing and its other output to the tail rotor, are in the same plane.

In drone mode, the controls are electric, while in passenger mode they are manual.

The aircraft according to the invention has its center of gravity located substantially along the axis of the rotor mast. Thus, according to the invention, the aircraft's center of gravity is substantially identical when the aircraft is empty or loaded. Advantageously, the aircraft is already balanced when empty.

The invention also covers a container for rotary-wing aircraft according to the present invention. This container comprises a framework with receiving means for receiving the various units of said aircraft:
structural core with drive motor and transfer gearbox,
tail and tail rotor,
skids unit, and
blades of the wing.

The container has six sides:
a lower face,
an upper face,
two front and rear faces, with at least one of them hinged to the lower face, and
two side faces.

The upper face is supported by vertical uprights, each comprising two coaxial upper and lower sections, telescopically mounted in relation to one another.

This container is also equipped with a maneuvering hoist, mounted on a beam, movable in relation to said upper face.

In a particular embodiment, the walls are made in the form of a sandwich, with a honeycomb core and light-alloy skins.

The rotary-wing aircraft according to the present invention is now described with the aid of examples that are purely illustrative and in no way limiting on the scope of the invention, and based on the attached drawings, in which the various figures show:

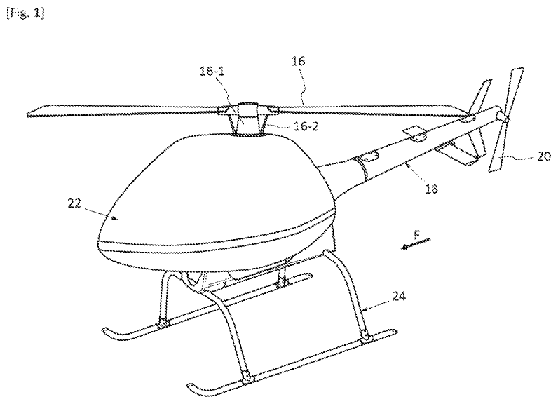

FIG. 1 shows a schematic perspective view of the rotary-wing aircraft according to the present invention, in drone version, with load-carrying capability.

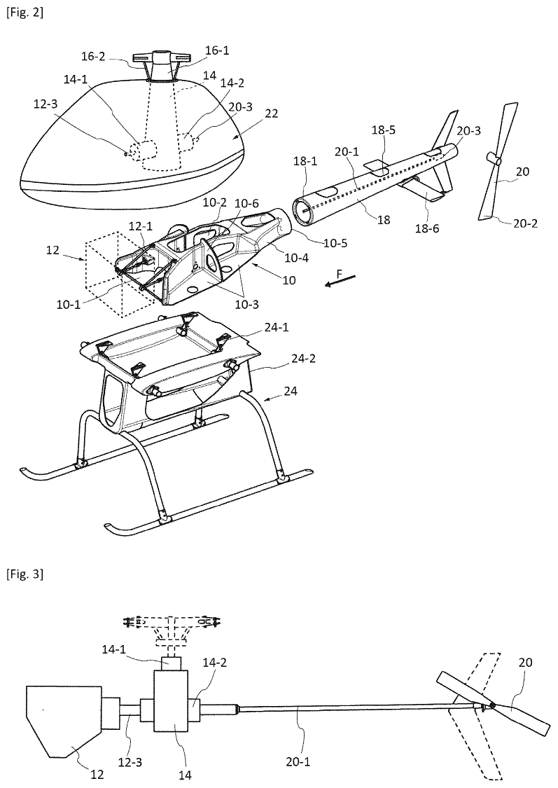

FIG. 2 shows a schematic exploded view of the various components of the rotary-wing aircraft shown in FIG. 1.

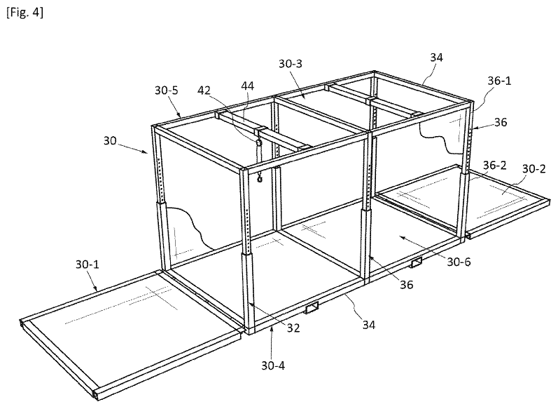

FIG. 3 shows a view of the kinematics of the transmission with its alignment.

FIG. 4 shows a view of a transport container of the rotary-wing aircraft, according to the present invention, before it is placed in said container.

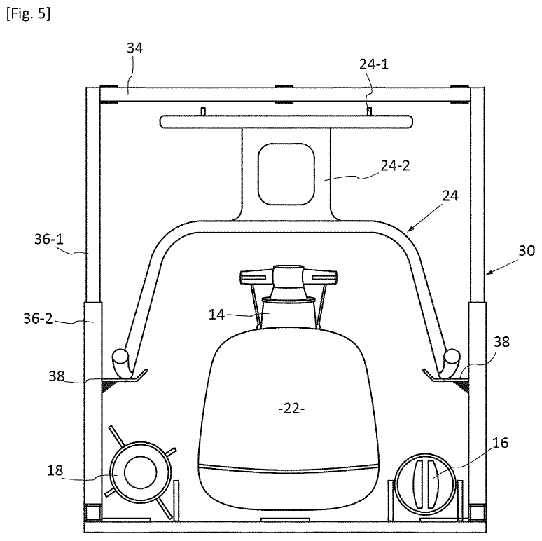

FIG. 5 shows a view of a rotary-wing aircraft transport container, according to the present invention, with the aircraft disassembled and in the transport position.

The rotary-wing aircraft according to the present invention is now described with reference to both FIG. 1 or 2.

The rotary-wing aircraft according to the present invention comprises a structural core 10, a drive motor 12, with a transfer gearbox 14, a rotary wing 16 and its controls, a tail 18, a tail rotor 20 and its controls, a cockpit 22 and a skids unit 24.

The structural core 10, shown in FIG. 2, is made of monolithic composite material. This monolithic structural core houses all the aircraft's components. Front and rear are considered in relation to the direction of flight symbolized by the arrow F. This monolithic structural core 10 comprises a front housing 10-1 designed to receive a cradle 12-1, itself suited for receiving the drive motor 12. A central housing 10-2 accommodates the transfer gearbox 14. On the sides of the structural core, open side recesses 10-3, in this case 4 side recesses in the embodiment shown, are designed to receive fuel tanks, intended to supply the drive motor 12. At the rear, the structural core 10 comprises an extension 10-4 terminating in a substantially hollow cylindrical shape, with an attachment flange 10-5. Structural reinforcements 10-6 are arranged laterally.

The drive motor 12 is mounted in the structural core and held by the cradle 12-1. This drive motor 12 comprises a motor output shaft 12-3 which is connected to the transfer gearbox 14. It is supplied with fuel from fuel tanks 12-2 in a known manner. The motor is an internal combustion motor of the type known, in particular, under the registered trademarks ROTAX or D-Motor, to supply and distribute the mechanical power required by the rotating wing 16 and tail rotor 20 to ensure their rotation.

The transfer gearbox 14 houses the motor output shaft 12-3 of the motor 12, and includes sets of stepped bevel gears and two outputs, one 14-1 to the rotating wing 16 and the other 14-2 to the tail rotor 20. This makes it possible to obtain a constant ratio of the differentiated rotational speeds of the rotary wing 16 and the tail rotor 20, based on a common rotational speed of the motor output shaft 12-3 of the drive motor 12.

As is well known, the rotary wing 16 comprises a rotor 16-1, in this case a rotor 16-1 having two blades 16-2 in the embodiment shown. This rotor 16-1 also includes, as is well known, the various bearings, shafts, bushes and linkages for controlling the incidence of the blades, the inclination of the rotor towards the front or rear, and/or towards the right or left sides to ensure elevation, descent, left or right turns and hovering. These various controls, which are not the subject of the present invention, are grouped together under the common reference 16-2. In the drone variant shown here, electric motors power the movements of these various controls 16-2, replacing manual controls in a piloted version.

The tail rotor 20 is connected to the output 14-2 of the transfer gearbox 14 by a drive shaft 20-1. The tail rotor 20 comprises two blades 20-2 and a bevel gear 20-3, so that the blades 20-2 of the tail rotor 20 can be rotated in a plane parallel to the direction of flight F. A control linkage 20-4 modifies the incidence of the blades, in a known way, to increase or decrease the anti-rotation torque, depending on the flight parameters and the parameters of the rotating wing.

The tail 18 is connected to the structural core 10 by a connecting flange 18-1 designed to cooperate, for example by means of a bayonet assembly, with the attachment flange 10-5 of the extension 10-4 terminating in a substantially hollow cylindrical shape of the monolithic structural core 10. Tail 18 is therefore removable. The profile of tail 18 is perfectly matched geometrically to that of extension 10-4 to ensure continuity of the outer surface and connection to flange 10-5. The tail 18 comprises access hatches 18-5 and other wing appendages 18-6, depending on aerodynamic requirements. The tail 18 accommodates the drive shaft 20-1 of the tail rotor 20 in its interior. The free end of the tail 18, opposite the end carrying the connecting flange 18-1, accommodates the tail rotor 20 and its angular gear 20-3.

The cockpit 22 is shown for the drone variant as indicated, that is, minimalist 22-1, housing the pilot controls and cockpit electronics, not shown. This cockpit 22 is aerodynamically shaped to limit drag, and is sturdy enough for its intended use, in particular to withstand impacts from birds, for example, or from munitions in the case of military applications. Cockpit 22 is a protective housing.

Note that the particular architecture of the aircraft according to the present invention is arranged so that the motor output shaft 12-3 of the motor 12, the transfer gearbox 14 with its first output 14-1 to the rotary wing 16 and its other output 14-2 to the tail rotor 20 are in the same plane. Note that motor shaft 12-3, transfer gearbox 14 with its output 14-2 and shaft 20-1 are perfectly aligned, see FIG. 3. This alignment leads to clear advantages in terms of compactness, reliability, improved efficiency, reduced mechanical losses and less wear and tear on parts, such advantages not being limiting. As a result, vibrations are also partly limited by this alignment, which is important for maintaining perfect structural integrity without the need for specific reinforcements, synonymous with additional weight and degraded performance.

According to the present invention, the rotary-wing aircraft has multiple applications. As is well known, it is necessary to provide a skids unit 24 to rest on the ground. Skids is understood to mean both rigid skids designed to rest on the ground and floating skids designed to rest on a liquid surface for certain applications. In the case of the present invention, the skids unit 24 comprises means 24-1 for connecting to the structural core 10 so as to make it removable.

These connecting means 24-1 are quick-release fasteners. This skids unit, according to the particularity of the present invention, comprises on-board components 24-2, linked to the application. In this case, to cite a first example of application, which is non-limiting and exemplary only, in the case of an application for aerial phytosanitary treatment, the skids unit 24 comprises a housing designed to receive a storage tank for said phytosanitary product, spray booms, and means for pumping and pressurizing said phytosanitary product to diffuse it through said booms. In a second example, no more limiting than the first, the skids unit 24 comprises a box designed to receive a load. This box can include in-flight opening/closing means to ensure in-flight release of the contents of said box.

Thus, it can be seen that the rotary-wing aircraft according to the invention comprises four units:
the structural core 10 with its transfer gearbox 14, drive motor 12 and rotor 16-1, as well as the cockpit 22 and its cockpit electronics,
the blades 16-2 of the rotary wing
the tail 18 and its tail rotor 20
the skids unit 24, with its equipment adapted to the intended application.

The rotary-wing aircraft according to the present invention is made up of removable units, in particular the tail 18, since this tail 18 only has to be uncoupled from the structural core 10 and the transmission shaft 20-1 driving the tail rotor disconnected at the output 14-2 of the transfer gearbox 14. The mechanical connection can be a splined shaft and a splined tube, as is well known. Similarly, the skids unit 24 can be easily uncoupled from the structural core 10 by removing the quick-release fasteners. In addition to easy access, servicing and maintenance, the rotary-wing aircraft according to the present invention can be transported in a restricted volume in the event of missions to remote territories, more particularly in the volume of a container of standardized dimensions.

The rotary-wing aircraft according to the present invention is made up of removable units, in particular the tail 18, since this tail 18 only has to be uncoupled from the structural core 10 and the transmission shaft 20-1 driving the tail rotor disconnected at the output 14-2 of the transfer gearbox 14. The mechanical connection can be a splined shaft and a splined tube, as is well known. Similarly, the skids unit 24 can be easily uncoupled from the structural core 10 by removing the quick-release fasteners. In addition to easy access, servicing and maintenance, the rotary-wing aircraft according to the present invention can be transported in a restricted volume in the event of missions to remote territories, more particularly in the volume of a container of standardized dimensions.

The object of the present invention is therefore also a transport container 30 designed to receive a rotary-wing aircraft, in particular that of the present invention. FIGS. 4 and 5 show this transport container 30. This transport container 30 according to the present invention allows the transport of the different units of the rotary wing aircraft according to the present invention, but also ensures the assembly/disassembly of these different units, constituting a workshop, this in particular for service in locations with little equipment. In addition, the transport container 30 according to the present invention comprises an architecture making it very light, which allows long-distance travel by air, without the weight straining the financial cost and/or the possibilities of land or air transport

The transport container 30 according to the present invention is parallelepiped in shape, with a front face 30-1, a rear face 30-2, an upper face 30-3, a lower face 30-4 and two side faces 30-5 and 30-6. A frame 32 provides mechanical rigidity. This frame 32 comprises tubular elements 34 along the four edges of the upper 30-3 and lower 30-4 faces and in the middle section, made of light alloy. The tubular elements 34 of these faces are braced by vertical uprights 36, 6 in number, arranged at each intersection, also made of light alloy. Each vertical upright 36 comprises two coaxial profiles, upper 36-1 and lower 36-2, telescopically mounted relative to one another, in this case upper profile 36-1 being slidable into lower profile 36-2. The upper sections 36-1 are integral with the tubular elements 34 on the upper face 30-3, and the lower sections 36-2 are integral with the tubular elements 34 on the lower face 30-4. The upper surface 30-3 can therefore be raised relative to the lower face. Disengageable locking means, for example, maintain the desired spacing.

The transport container comprises panels 40 attached to the frame 32. These panels are advantageously, in the selected mode, are made of a material with a honeycomb core and light metal alloy foil skins. Panels of this type are extremely rigid, and at the same time very lightweight. At least one of the front 30-1 and rear 30-2 faces is pivotally mounted relative to the lower 30-4 face, so that the front and rear faces can be opened and rested on the ground. In this way, the front 30-1 and rear 30-2 faces are positioned in the same plane as the lower face to form a long, clean floor, enabling assembly work to be carried out in any area, even on natural terrain.

Advantageously, the upper face 30-3 comprises a maneuvering hoist 42, mounted on a beam 44 movable relative to said upper face 30-3, below said upper face, along the front/rear axis of the container. The maneuvering hoist 42 can be moved in translation on said beam, that is, transversely to the front/rear axis. This hoist 42 can be used to move the various component units of the rotary-wing aircraft according to the present invention, for both assembly and disassembly, in any location, even if isolated. Even though the weight of the parts is reduced, the number of component parts being limited, the weight of each part is greater than the capability of workers, especially when the aim is to be able to operate with a small number of operators. Furthermore, the container's dimensions are precisely tailored to the dimensions of the parts, and the peripheral space for workers to move about is very limited.

The rotary-wing aircraft according to the present invention is arranged in a special way in the container to gain compactness. The blades are removed from the main rotor. The tail 18 is disassembled, as is the skids unit 24. The container is also equipped with means for accommodating the various units:
structural core 10 with drive motor 12 and transfer gearbox 14,
tail 18 and tail rotor 20
skids unit 24
blades 16-2 of wing 16.

The rotary-wing aircraft according to the present invention is set up as shown more particularly in FIG. 5. The dismantled blades are advantageously placed in a lateral receptacle at the bottom. The tail 18 and its tail rotor are also placed in a suitable cradle on the opposite side of the blades. The structural core assembly, with its motor, transfer gearbox, motor and rotor, is placed on a cradle sliding on the lower face in the middle section. The skids unit 24 is positioned above the central frame and rests on lateral supports 38 attached to the side faces, so that the rotor can be positioned in the free space beneath the skids, with an essential gain in compactness. Clamping is provided by any means, although this is not the essence of the invention and can be adapted without inventive effort.

The aircraft according to the present invention features a simple yet easy-to-implement design, with a high degree of versatility. In fact, the cockpit can be modified to include manual controls in place of the drone's electric motor controls, and two seats for the pilot and co-pilot or passenger or operator. The components remain identical. Both size and weight are perfectly acceptable for transport by land, sea or air, and in particular by helicopter as close as possible to work areas when necessary. Missions are highly versatile, with a skids unit adapted to the mission brought in almost immediately. The rotary-wing aircraft according to the present invention is made by molding entirely of carbon fibers and inserts of a strong, light alloy such as titanium. The structural core 10, in particular, is made of carbon-fiber composites to create a lightweight element with strong mechanical properties, since it accommodates all the aircraft components connected to the core. Mechanical parts can be obtained from machined titanium, especially for transmissions, which are usually very heavy. The motor itself can be standard, but can also be developed to deliver increased power, making the rotary-wing aircraft according to the present invention even more powerful, especially for military applications. As a result, the aircraft's weight is kept to a minimum, enabling it to carry a greater payload and deliver excellent flight performance.

1. A rotary wing aircraft, comprising:
a drive motor (12) with a motor output shaft (12-3),
a transfer gearbox (14) having the motor output shaft (12-3) as an input and having a first output (14-1) and a second output (14-2),
a cockpit (22) with cockpit electronics,
a rotary wing (16) with rotor (16-1) and blades (16-2),
a tail (18) and its tail rotor (20) with a drive shaft (20-1) for said tail rotor, and
a skids unit (24) with equipment suited to the intended application,
characterized in that the drive shaft (12-3) of the motor (12), the transfer gearbox (14) with its second output (14-2) and the drive shaft (20-1) of the tail rotor (20) are aligned.

2. The rotary-wing aircraft according to claim 1, wherein it comprises a structural core (10) and in that said structural core is monolithic.

3. The rotary-wing aircraft according to claim 1, wherein the structural core (10) is made of carbon-fiber composites.

4. The rotary-wing aircraft according to claim 1, wherein the structural core (10) comprises lateral housings suitable for receiving the fuel tanks required by the drive motor (12).

5. The rotary-wing aircraft according to claim 1, characterized in that wherein the skids unit (24) is connected to the structural core (10) by quick-release fasteners.

6. The rotary-wing aircraft according to claim 1, wherein the tail (18) comprises a connecting flange (18-1) and the structural core (10) comprises an attachment flange (10-5) suited to cooperate with said connecting flange (18-1).

7. The rotary-wing aircraft according to claim 1, wherein the structural core (10) comprises a cradle (12-1) for receiving the drive motor (12).

8. The rotary-wing aircraft according to claim 1, wherein the motor output shaft (12-3) of the motor (12), the transfer gearbox (14) with its first output (14-1) to the rotary wing (16) and its other output (14-2) to the tail rotor (20) are in the same plane.

9. The rotary-wing aircraft according to claim 1, wherein in drone mode, the controls are electric.

10. The rotary-wing aircraft according to claim 1, wherein in passenger-carrying mode, the controls are manual.
